(19) United States
(12) Patent Application Publication
(10) Pub. No.: US 2024/0274849 A1
(43) Pub. Date: Aug. 15, 2024

(54) MODIFICATION OF PERFLUORINATED POLYMERS, IONOMERS, AND MEMBRANES USING PERFLUORINATED LINKERS

(71) Applicant: 1s1 Energy, Inc., Portola Valley, CA (US)

(72) Inventors: Sukanta Bhattacharyya, Belmont, CA (US); Daniel Sobek, Portola Valley, CA (US)

(21) Appl. No.: 18/682,616

(22) PCT Filed: Aug. 9, 2022
(86) PCT No.: PCT/US2022/039845

§ 371 Date: Feb. 9, 2024

Related U.S. Application Data
(60) Provisional application No. 63/231,634, filed on Aug. 10, 2021.

(51) Int. Cl. H01M 8/1039; H01M 8/10; H01M 8/1004; H01M 8/1072; H01M 8/1086

(52) U.S. Cl. CPC H01M 8/1039; H01M 8/1004; H01M 8/1072; H01M 8/1086; H01M 2008/1095; H01M 2300/0082

(57) ABSTRACT

A membrane electrode assembly includes a polyfluorinated polymer and a polyfluorinated linker bound to the polyfluorinated polymer by a fluorine-fluorine affinity interaction. The membrane electrode assembly may also include a polyfluorinated ionomer bound to the polyfluorinated linker. The membrane electrode assembly may further include a catalyst bound to the polyfluorinated linker.

### RELATED APPLICATIONS

The present application claims priority to U.S. Provisional Patent Application No. 63/231,634, filed Aug. 10, 2021, which is hereby incorporated by reference in its entirety.

### BACKGROUND INFORMATION

In electrochemical cells, such as hydrogen fuel cells and water electrolysis systems, proton exchange membranes (PEM) are used to selectively transport protons. Proton exchange membranes (PEMs) are semipermeable membranes that transport protons (H⁺) while being impermeable to gases. PEMs are generally composed of a porous framework with highly acidic functional groups. For example, polyfluorosulfonic acid-based PEMs contain a polytetrafluoroethylene (PTFE) porous framework with sulfonic acid groups. The easily dissociable sulfonic acid groups serve as proton transport agents in the membrane. In hydrogen fuel cells, hydrogen gas (H₂) separates at the anode into protons (H⁺) and electrons. The protons pass through a PEM and combine with oxygen gas (O₂) at a cathode to produce water while the electrons flow through an external circuit to produce electricity. In water electrolysis systems, electricity splits water at the anode into oxygen gas (O₂) and protons (H⁺). The protons pass through the PEM and combine with electrons at the cathode to produce hydrogen gas (H₂).

A catalyst-coated membrane is generally composed of catalyst layers coated on either side of a PEM. A catalyst layer is a porous medium composed of catalyst particles (alone or supported on an electrically conducted medium, such as carbon supports) and ionomers. The catalyst particles facilitate the electrochemical reactions at the cathode and anode. The ionomer binds the catalysts within the electrode, binds the catalyst layer on the PEM, and provides a pathway for protons, thereby improving proton conductivity. The hydrophobic or hydrophilic nature of the ionomer may also help remove byproducts of the electrochemical reactions away from the catalyst layer. For example, a hydrophobic ionomer may help remove water produced in a hydrogen fuel cell. Thus, the ionomer greatly affects performance of the catalyst-coated membrane.

Performance of a hydrogen fuel cell may be affected by water flooding, wherein more water is retained than required. Accumulation of water onto the cathode side of a hydrogen fuel cell wherein reduction of oxygen happens may limit the oxygen mass transport, thereby compromising performance of the hydrogen fuel cell. The operating conditions of a hydrogen fuel cell may affect water flooding. At low temperature operating conditions, the reactant gases inside a fuel cell may become oversaturated with water condensation, thereby causing water flooding of the catalyst-coated membrane. On the other hand, if the water excretion rate becomes higher than the water generation rate, the catalyst-coated membrane may become dehydrated, compromising the performance of the hydrogen fuel cell. Accordingly, optimal humidification of a catalyst-coated membrane in hydrogen fuel cells helps maintain continuous proton transport from the anode side of the catalyst-coated membrane to the cathode side.

Performance of a hydrogen fuel cell and a water electrolysis system may also be affected by the contact adhesion between catalysts and ionomers in the catalyst layer, as well as between the catalyst layer and PEM in a catalyst-coated membrane. For example, catalyst particles may separate from the catalyst layer and enter the PEM and damage the PEM. Performance of a hydrogen fuel cell may also be affected by the equivalent weight or ion-exchange capacity (IEC) of the ionomer and PEM. The equivalent weight is the weight of polymer per mol of active sites (e.g., SO₃⁻) and corresponds to the inverse of the IEC. IEC represents the number of active sites or functional groups that are responsible for ion exchange per gram of the polymer.

Performance of a hydrogen fuel cell and water electrolysis system may also be affected by the mechanical durability of the PEM and/or catalyst-coated membrane. For example, water electrolysis systems may have different amounts of relative stress between the PEM membrane and the catalyst layer depending on how they swell relative to each other with uptake of water. The more residual stress difference between catalyst layers and the PEM, the greater the risk of lamination.

### SUMMARY

The following description presents a simplified summary of one or more aspects of the apparatuses, compositions, and/or methods described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the apparatuses, compositions, and/or methods described herein in a simplified form as a prelude to the more detailed description that is presented below.

In some examples, an illustrative membrane electrode assembly comprises a polyfluorinated polymer; and a polyfluorinated linker bound to the polyfluorinated polymer by a fluorine-fluorine affinity interaction.

In some examples, an illustrative method of making a membrane electrode assembly comprises binding a polyfluorinated linker with a polyfluorinated polymer by a fluorine-fluorine affinity interaction.

In some examples, an illustrative method of making a catalyst-coated membrane comprises combining a polyfluorinated polymer, a polyfluorinated linker, a polyfluorinated ionomer, and a catalyst in a one-pot process.

In some examples, an illustrative method of making a membrane electrode assembly comprises binding an acid-unfunctionalized polyfluorinated polymer with an acid-functionalized polyfluorinated linker by a fluorine-fluorine affinity interaction.

In some examples, an illustrative polyfluorinated linker-modified polymer comprises a polyfluorinated polymer; and a polyfluorinated linker bound to the polyfluorinated polymer by a fluorine-fluorine affinity interaction.

### BRIEF DESCRIPTION OF THE DRAWINGS

In order that the concepts described herein may be better understood, various embodiments will be described by way of example only, with reference to the drawings. The drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative scheme for producing a polyfluorinated linker-modified polymer.

FIG. 2 shows an illustrative scheme for binding a first polyfluorinated polymer to a second polyfluorinated polymer by way of a polyfluorinated linker.

FIG. 3 shows another illustrative scheme for producing a polyfluorinated linker-modified polymer.

FIG. 4 shows an illustrative scheme for binding a first polyfluorinated polymer to a second polyfluorinated polymer by way of a bi-functional polyfluorinated linker.

FIG. 5 shows an illustrative scheme for binding a polyfluorinated polymer (e.g., an ionomer or a PEM) with a metal catalyst.

FIG. 6 shows an illustrative scheme for binding a first polyfluorinated polymer, a second polyfluorinated polymer, and a catalyst using a tri-functional polyfluorinated linker to produce a catalyst-coated membrane.

FIG. 7A shows an illustrative scheme for modification of an unfunctionalized polyfluorinated polymer (e.g., a polymer not functionalized with an acid group) into an acid-functionalized polymer with a pendant acidic group.

FIG. 7B shows the general structure of 4F-PBI, which includes a tetrafluorobenzene moiety within the main chain that may link, by way of the fluorine-fluorine affinity interaction, with a polyfluorinated linker.

FIG. 8 shows an illustrative scheme for formation of a catalyst-coated proton-exchange membrane using an unfunctionalized polyfluorinated polymer.

FIG. 9 shows an illustrative proton exchange membrane water electrolysis system incorporating polyfluorinated linker-modified porous polymers.

FIG. 10 shows an illustrative proton exchange membrane fuel cell incorporating polyfluorinated linker-modified porous polymers.

### DETAILED DESCRIPTION

Polyfluorinated linker-modified polymers, apparatuses using the same, and methods of making the same, are described herein. For example, a membrane electrode assembly may include a polyfluorinated polymer and a polyfluorinated linker bound to the polyfluorinated polymer by a fluorine-fluorine affinity interaction. In further examples, the membrane electrode assembly may include a polyfluorinated ionomer bound to the polyfluorinated linker. In yet further examples, the membrane electrode assembly may include a catalyst bound to the polyfluorinated linker.

As used herein, an “ionomer” refers to a polymer composed of macromolecules in which a small but significant proportion (e.g., about 15 mol % or less) of the constitutional units has ionic or ionizable groups (e.g., a sulfonic acid group, a carboxylic acid group, a phosphoric acid group, a tetravalent boron-based acid group, etc.), or both.

As used herein, “polyfluorinated” means having multiple sites where hydrogen is substituted with fluorine (e.g., having multiple carbon-fluorine bonds). Polyfluorinated may refer to a polymer, a compound (stoichiometric or non-stoichiometric), a molecule, or a moiety within a polymer, compound, or molecule (e.g., a tag or ponytail). Polyfluorinated does not require having exclusively carbon-fluorine bonds, being exclusively substituted with fluorine, or having total substitution. For example, a polyfluorinated species may also be substituted with atoms or groups including nitrogen, chlorine, sulfur, and/or oxygen atoms, and may be only partially substituted (e.g., may also include carbon-hydrogen bonds). Furthermore, a polyfluorinated species may include a non-fluorinated molecule or domain of a molecule having a polyfluorinated moiety, such as a polyfluorinated ponytail or fluorous tag. A polymer or ionomer is polyfluorinated when it has (1) a polyfluorinated moiety in the polymer backbone, (2) a polyfluorinated side chain, and/or (3) a polyfluorinated moiety in a side chain.

As used herein, “perfluorinated” means all sites where hydrogen is bonded to carbon are substituted with fluorine (e.g., all carbon-hydrogen bonds are replaced with carbon-fluorine bonds). Perfluorinated may refer to a polymer, a compound, a molecule, or a moiety within a polymer, compound, or molecule. A polymer may include a perfluorinated side chain or a perfluorinated group on a side chain, but the polymer itself is perfluorinated only when all hydrogen sites within the polymer backbone and any side chains have been substituted with fluorine. A perfluorinated compound is also polyfluorinated.

A polyfluorinated substance may be attracted toward another polyfluorinated substance, such as a polyfluorinated molecule, polymer, and/or solvent, through strong, intermolecular fluorine-fluorine affinity interactions. Fluorine-fluorine affinity interactions are partial bonds that are different from hydrophobic and hydrophilic interactions. Fluorine is the most electronegative element among all the elements in the periodic table. The fluorine-fluorine affinity mechanism is believed to involve a partial overlap of electron density between the two interacting fluorine atoms minimizing their high electron density repulsions through the attractive forces of the two involved fluorine nuclei. Fluorine-fluorine affinity interactions may be stronger than covalent bonds and are particularly stable under aqueous environments. As will now be described, the fluorine-fluorine affinity interaction may be used to improve the adhesion contact between polymers, ionomers, membranes, and/or catalysts in electrochemical cells.

In some examples, a polyfluorinated polymer is bound (e.g., linked) with a polyfluorinated linker by a fluorine-fluorine affinity interaction to produce a polyfluorinated linker-modified polymer.

In some examples, the polyfluorinated polymer is an acid-functionalized polymer. The acid-functionalized polymer is functionalized with a pendant acid group in the main chain and/or in side chains. The pendant acid group serves as a Lewis acid and may include, without limitation, a sulfonic acid group, a carboxylic acid group, a phosphoric acid group, a phosphonic acid group, a phosphate group, a phenol group, a boronic acid group, an alcohol group, or a hydroxyl group. In some examples, the pendant acid group is a tetravalent boron-based acid group as described in International Application No. PCT/US2021/029705 and International Application No. PCT/US2021/038956, which are incorporated herein by reference in their entireties.

In some examples, the acid-functionalized polyfluorinated polymer is an ionomer. Examples of an acid-functionalized polyfluorinated ionomer include, without limitation, a sulfonic acid-functionalized polyfluorinated polymer, such as a polyfluorosulfonic acid polymer, a perfluorinated sulfonic acid polymer, or a sulfonated PTFE-based fluoropolymer-copolymer. Examples of the acid-functionalized polyfluorinated polymer include, without limitation, ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene and tetrafluoroethylene-perfluoro-3,6-dioxa-4-methyl-7-octenesulfonic acid copolymer, polytrifluorostyrene sulfonic acid-based polymer, a polyfluorocarbon phosphonic acid-based polymer, a trifluorostyrene sulfonic acid-based polymer, an ethylene tetrafluoroethylene-g-styrene sulfonic acid-based polymer, an ethylene-tetrafluoroethylene copolymer, a polyvinylidene fluoride-polyfluorocarbon sulfonic acid-based polymer, an ethylene-ethylene tetrafluoride copolymer, or trifluorostyrene. Commercially available sulfonic acid-functionalized polyfluorinated polymers include, without limitation, Nafion® (available from E.I. Dupont de Nemours and Company in various configurations and grades, including, without limitation, Nafion-H, Nafion HP, Nafion 117, Nafion 115, Nafion 212, Nafion 211, Nafion NE1035, Nafion XL, etc.), Aquivion® (available from Solvay S.A. in different configurations and grades, including Aquivion® E98-05, Aquivion® PW98, Aquivion® PW87S, etc.), Gore-Select® (available from W.L. Gore & Associates, Inc.), Flemion™ (available from Asahi Glass Company), Pemion+™ (available from Ionomr Innovations, Inc.), and any combination, derivative, grade, or configuration thereof.

In some examples, the polyfluorinated polymer includes side chains that link the pendant acid groups to the polymer main chain. The side chain may have any suitable configuration. In some examples, the side chains have a chain length of one (1) to thirty (30) atoms comprising carbon, oxygen, sulfur, and/or nitrogen atoms. The side chain optionally has one or more pendant moieties, which may be the same or different for each atom in the side chain and which may comprise hydrogen, a hydroxyl group, a fluoro group, a chloro group, a dialkylamino group, a cyano group, a carboxylic acid group, a carboxylic amide group, an ester group, an alkyl group, an alkoxy group, or an aryl group. In some examples, the side chains are polyfluorinated (e.g., include one or more polyfluorinated moieties). Short-side chain (SSC) ionomers, such as Aquivion, generally have a side chain length of less than eight atoms, and long-side-chain (LSC) ionomers, such as Nafion, generally have a side chain length of eight or more atoms.

The polyfluorinated polymer may have any suitable structure. In some examples, the polyfluorinated polymer is or is included in a membrane (e.g., a PEM). For example, the polyfluorinated polymer may be part of a porous polymer network. Additionally or alternatively, the polyfluorinated polymer is a resin bead or polymer particle. In yet further examples, the polyfluorinated polymer is an ionomer in a catalyst layer or a catalyst-coated membrane.

The polyfluorinated linker is a polyfluorinated alkyl chain having one (1) to thirty (30) atoms comprising carbon, oxygen, and/or nitrogen atoms, may be branched or unbranched, may be saturated or unsaturated (e.g., contain alkene, alkyne, and/or cyclic unsaturated structures such as polyfluorinated benzene rings), includes one or more polyfluorinated moieties, and, apart from polyfluorinated moieties, may be substituted or unsubstituted. In some examples, the polyfluorinated linker is functionalized with one or more terminal functional groups such as an acid group (e.g., sulfonic acid, carboxylic acid, phosphonic acid, or boronic acid (including fluorinated boronic acids wherein one or two hydroxyl groups is replaced by fluorine)), an amino group (primary, secondary, or tertiary), and/or an alcohol group (e.g., hydroxyl group).

Illustrative examples of polyfluorinated linkers include, without limitation, fluoroalkanes (e.g., tetrafluoromethane (TFM), tetrafluoroethylene (TFE), hexafluoroethane, octafluorocyclobutane, perfluorooctane, perfluorodecalin, polyethylene glycol (PEG)), fluoroalkenes, fluoroalkynes, polyfluorinated dendrimers, fluorotelomer-based compounds, perfluoroalkyl acids (PFAAs) such as perfluoroalkyl carboxylic acids and perfluoroalkyl carboxylates (PFCAs) (e.g., perfluorooctanoic acid (PFOA)), perfluoroalkyl sulfonic acids and perfluoroalkyl sulfonates (PFSAs) (e.g., perfluorooctane sulfonic acid), polyfluorinated ether carboxylates (e.g., 4,8-dioxa-3H-perfluorononanoate), polyfluorinated ether sulfonates (e.g., perfluoro hexyl ethyl ether sulfonate), perfluorinated cyclo sulfonates (e.g., PFECHS), perfluoroalkane sulfonamides (FASAs) (e.g., perfluorooctane sulfonamide (FOSA)), perfluorophosphonic and perfluorophosphinic acids (e.g., PFOPA, 8:8 PFPI), fluorotelomer alcohols (FTOHs) such as fluorotelomer sulfonic acids (FTSAs) (e.g., 8:2 FTSA), fluorotelomer carboxylic acids (FTCAs) (e.g., 6:2 FTCA, 5:3 FTCA), and fluorotelomer phosphate esters (e.g., 8:2 monoPAP, 8:2 diPAP), polyfluoroalkyl ether carboxylic acids, and perfluoroalkane sulfonamido substances such as N-alkyl perfluoroalkane sulfonamides (e.g., N-Ethyl perfluorooctane sulfonamide (EtFOSA), N-Methyl perfluorooctane sulfonamide (MeFOSA)), perfluoroalkane sulfonamido ethanols (FASEs) and N-alkyl perfluoroalkane sulfonamido ethanols (e.g., N-Ethyl perfluorooctane sulfonamidoethanol (EtFOSE), N-Methyl perfluorooctane sulfonamido ethanol (MeFOSE)), and perfluoroalkane sulfonamido acetic acids (FASAAs) and N-alkyl perfluoroalkane sulfonamido acetic acids (e.g., N-Ethyl perfluorooctane sulfonamido acetic acid (EtFOSAA), N-Methyl perfluorooctane sulfonamido acetic acid (MeFOSAA)).

In some examples, a functionalized polyfluorinated linker may be modified with boron trifluoride (BF₃) or a polyatomic metal fluoride (e.g., zirconium fluoride (ZrF₄), titanium fluoride (TiF₄), tin fluoride (SnF₄), and/or aluminum fluoride (AlF₄)) to generate a metal fluoride-based acid group. When the boron atom or the metal atom of the polyatomic metal fluoride covalently bonds with the functional group of the functionalized polyfluorinated linker, the boron atom or the metal atom expands its valence to accept an electron and thereby gains a negative formal charge and becomes intrinsically acid and ionic. In this way, the polyfluorinated linker may be functionalized with a tetravalent boron-based acid group and/or a metal fluoride-based acid group.

The composition and structure of the polyfluorinated linker affects the hydrophobicity and hydrophilicity of the polyfluorinated linker-modified polymer. Accordingly, a polyfluorinated linker-modified polymer (e.g., a polyfluorinated linker-modified PEM) with the desired hydrophobic/hydrophilic characteristics can be obtained by selecting the appropriate polyfluorinated linker. Factors that may affect the hydrophobicity/hydrophilicity of the polyfluorinated linker include, for example, the length of the alkyl chain, terminal functional groups, and any side groups or side chains of the alkyl chain.

In some examples, the polyfluorinated linker is used as a coating reagent to coat pore surfaces of polyfluorinated PEMs and/or polyfluorinated ionomers in catalyst layers. The polyfluorinated coating reagents may improve water management in catalyst layers and catalyst-coated membranes in hydrogen fuel cells and water electrolysis systems.

In some examples, the polyfluorinated linker may also be used to improve contact adhesion between polymers, ionomers, and/or catalysts in a catalyst layer and/or a catalyst-coated membrane. In these examples, the polyfluorinated linker is bi-functional or tri-functional. As used herein, “bi-functional” means having two linking groups each of which has chemical facilities for binding to a polymer, ionomer, and/or a catalyst. In some examples, both linking groups are polyfluorinated and each links with another polyfluorinated moiety in another compound by the fluorine-fluorine affinity interaction. In further examples, a first linking group is polyfluorinated and a second linking group comprises a tertiary amino group (—NR₃), an alkoxy or aryloxy group (RO—), a hydroxyl group (—OH), or an acid group (e.g., a carboxylic acid group (—COOH), a sulfonic acid group (—SO₃H), a phosphoric acid group, a phosphonic acid group, a phosphate group, a boronic acid group, etc.).

As used herein, “tri-functional” means having three linking groups each of which has chemical facilities for binding to a polymer, ionomer, and/or a catalyst. In some examples, any one or more of the linking groups are polyfluorinated and each links with another polyfluorinated moiety in another compound by the fluorine-fluorine affinity interaction. In further examples, at least one linking group is polyfluorinated and one or more other linking groups comprises a tertiary amino group (—NR₃), an alkoxy or aryloxy group (RO—), a hydroxyl group (—OH), or an acid group (e.g., a carboxylic acid group (—COOH), a sulfonic acid group (—SO₃H), a phosphoric acid group, a phosphonic acid group, a phosphate group, a boronic acid group, etc.).

As used herein, a “catalyst” refers to a catalyst particle in “black” or pure form as well as one or more catalyst particles in supported form (e.g., supported on a catalyst support) and with or without catalyst additives. Suitable catalyst particles may include, without limitation, metals (e.g., platinum group metals such as platinum, palladium, iridium, ruthenium, and rhodium), transition metals (e.g., silver, gold, cobalt, copper, iron, nickel, and tin), metal alloys (e.g., platinum group metal alloys with transition metals and platinum-ruthenium based alloys), and/or metal oxides (e.g., iridium ruthenium oxide, iridium oxide, and cerium(IV) oxide). Suitable catalyst supports may include, without limitation, carbon (e.g., graphite), titanium dioxide (TiO₂), hexagonal boron nitride (h-BN) as described in U.S. Provisional Patent Application No. 63/286,988, and niobium boride, as described in U.S. Provisional Patent Application No. 63/320,148, which are hereby incorporated by reference in their entireties.

In some examples, a bi-functional or tri-functional polyfluorinated linker binds a catalyst to a polyfluorinated polymer or ionomer. For example, a bi-functional or tri-functional polyfluorinated linker binds, by a first linking group, to a polyfluorinated polymer by the fluorine-fluorine affinity interaction and binds, by a second linking group, to a catalyst. The polyfluorinated polymer may be, for example, an ionomer or a PEM. The catalyst generally has affinity to oxygen and/or nitrogen ligands of the second linking group in the polyfluorinated linker, thereby strongly maintaining the catalyst in proximity to the polyfluorinated polymer and thereby reducing or preventing catalyst migration.

In some examples, a bi-functional or tri-functional polyfluorinated linker binds a first polyfluorinated polymer to a second polyfluorinated polymer. For example, a first linking group of the bi-functional or tri-functional linker binds to a first polyfluorinated polymer by the fluorine-fluorine affinity interaction and a second linking group of the bi-functional or tri-functional linker binds to a second polyfluorinated polymer by the fluorine-fluorine affinity interaction. Alternatively, the second linking group of the bi-functional or tri-functional linker may bind to the second polyfluorinated polymer by a covalent bond rather than by the fluorine-fluorine affinity interaction. For example, the second linking group (e.g., a pendant acid group, amino group, or hydroxyl group) of the bi-functional or tri-functional polyfluorinated linker may bind to a corresponding linking group (e.g., a pendant acid group) on the second polymer. The first polyfluorinated polymer may be, for example, a PEM and the second polyfluorinated polymer may be, for example, an ionomer. Additionally or alternatively, a porous polymer network (e.g., a PEM) may be formed by binding polyfluorinated polymers to one another by way of polyfluorinated linkers.

In examples including a tri-functional polyfluorinated linker, a third linking group of the tri-functional linker may bind to a catalyst, as described above. Thus, a catalyst-coated membrane may be formed including a PEM and a catalyst layer formed of an ionomer and a catalyst. In some examples, a catalyst-coated membrane may be formed in a one-pot process by combining a PEM and ionomer (at least one of which is polyfluorinated), a polyfluorinated linker, and a catalyst in one pot. In alternative examples, a catalyst-coated membrane may be formed in a multi-step process. For example, a catalyst ink composition may be formed by combining a polyfluorinated ionomer, a polyfluorinated linker, and a catalyst in a colloidal suspension. The catalyst ink composition may then be sprayed onto a PEM, wherein the polyfluorinated linker binds to the PEM by the fluorine-fluorine affinity interaction or by a covalent bond, as described above.

The fluorine-fluorine affinity interaction may also be used to modify an unfunctionalized polyfluorinated polymer to obtain an acid-functionalized polyfluorinated polymer. As used herein, “unfunctionalized” means not functionalized with a pendant acid group, not ionized, or not ionizable (as in an ionomer). To obtain an acid-functionalized polyfluorinated polymer, a bi-functional or tri-functional polyfluorinated linker comprising a pendant acid group may be combined with and bind to an unfunctionalized polyfluorinated polymer by the fluorine-fluorine affinity interaction. Illustrative examples of an unfunctionalized polyfluorinated polymer include, without limitation, polytetrafluorethylene (PTFE), a polyfluorinated polybenzimidazole (PBI) polymer (e.g., 4F-PBI), and polytrifluorostyrene. The unfunctionalized polyfluorinated polymer may be in any form, such as a resin bead or a porous polymer network (e.g., a PEM). The acid-functionalized polyfluorinated linker may be any acid-functionalized polyfluorinated linker described herein. The resulting polyfluorinated linker-modified polymer is acid-functionalized with the pendant acid group of the polyfluorinated linker. In this way, an ionomer and/or PEM may be easily obtained from an unfunctionalized polyfluorinated polymer. In some examples, an acid-functionalized polyfluorinated polymer (e.g., Nafion® or Aquivion®) may be modified with an acid-functionalized polyfluorinated linker to increase the ion-exchange capacity (IEC) and decrease the equivalent weight of the polyfluorinated polymer to a desired level.

The polyfluorinated linker-modified, acid-functionalized polymer may be used in any way described herein. For example, the polyfluorinated linker may be bi-functional or tri-functional and thus may be used to link the unfunctionalized polyfluorinated polymer, an ionomer, and/or a catalyst to form a catalyst-coated membrane. In some examples, the catalyst-coated membrane may be formed in a one-pot process, as described above, by combining the unfunctionalized polyfluorinated polymer, ionomer, polyfluorinated linker, and catalyst in one pot. Alternatively, the catalyst-coated membrane may be formed in a multi-step process by forming a catalyst ink and spraying the catalyst ink on an unfunctionalized polyfluorinated PEM.

Polymers, ionomers, membranes (e.g., PEMs), and catalysts bound using a polyfluorinated linker, as described herein, provide various benefits over conventional polymers, ionomers, membranes, and catalysts. For example, the chain length and/or substituent groups of the polyfluorinated linker may be adjusted and selected to fine-tune the hydrophobic-hydrophilic properties of the PEM, catalyst layer, and/or catalyst-coated membrane. Thus, the polyfluorinated linker may help maintain a delicate water balance, thereby improving performance of a hydrogen fuel cell and/or electrolyzer.

Additionally, due to the strong fluorine-fluorine affinity interaction, the polyfluorinated linker may also improve the mechanical durability of the PEM and catalyst-coated membrane and may improve contact adhesion between catalysts/electrodes and ionomers in the catalyst layer and contact between the ionomer/catalyst layer and PEM in the catalyst-coated membrane. Increasing the contact adhesion in this way improves stability of the catalyst-coated membrane and reduces catalyst loss due to catalyst migration.

Various illustrative examples will now be described. It will be understood that the following examples are merely illustrative and are not limiting.

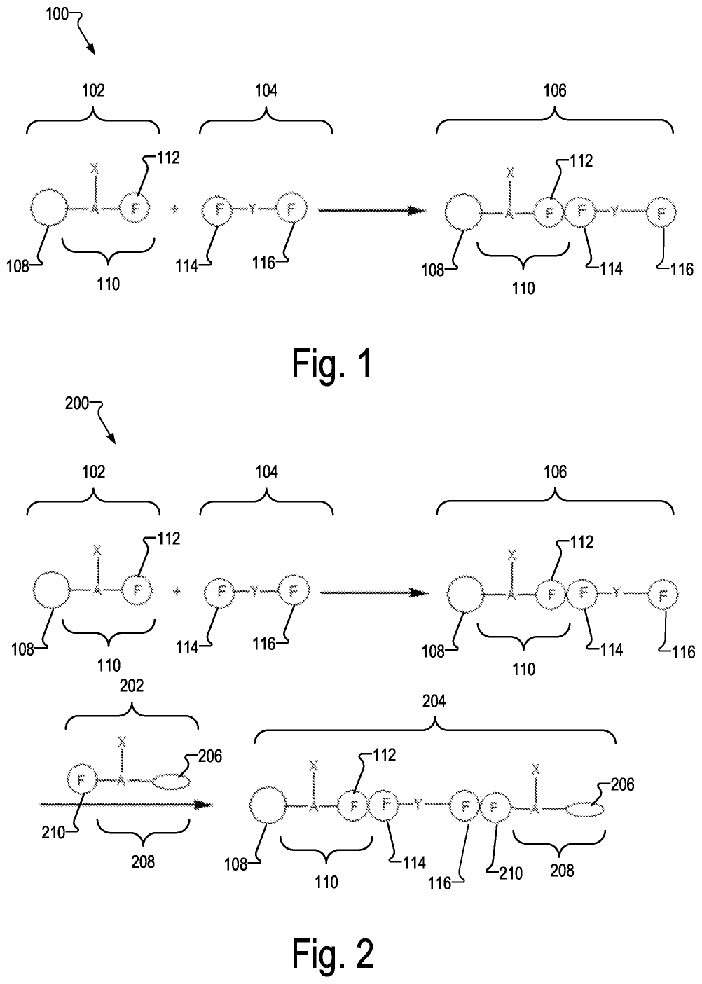

FIG. 1 shows an illustrative scheme 100 for surface modification of a polyfluorinated polymer surface using a polyfluorinated linker. As shown, a polyfluorinated polymer 102 is modified using a polyfluorinated linker 104 to produce a polyfluorinated linker-modified polymer 106. Polyfluorinated polymer 102 may be, for example, an ionomer or a membrane (e.g., a PEM) and may be implemented by any polyfluorinated polymer described herein (e.g., a polyfluorosulfonic acid polymer such as Nafion® or Aquivion®). Polyfluorinated polymer 102 includes a main chain 108 and a polyfluorinated side-chain 110 comprising a chain A and a pendant acid group X. Chain A has one (1) to 30 (thirty) atoms, may be branched or unbranched, contains carbon, oxygen, and/or nitrogen atoms, may be saturated or unsaturated and, apart from polyfluorinated moieties, may be substituted or unsubstituted. Pendant acid group is any pendant acid group described herein. To show the fluorine-fluorine affinity interaction, FIG. 1 shows a polyfluorinated moiety 112 (indicated by an F in a circle). Polyfluorinated moiety 112 may be a part of chain A and may be any suitable polyfluorinated moiety, such as —CF₃, —CF₂—, or —CF₂—CF₂—. While FIG. 1 shows only one polyfluorinated moiety 112, side-chain 110 (e.g., chain A) may include any other number of polyfluorinated moieties. Furthermore, although not shown in FIG. 1, main chain 108 may include one or more polyfluorinated moieties.

Polyfluorinated linker 104 is a polyfluorinated linker represented by alkyl chain Y and may be any polyfluorinated linker described herein. For example, chain Y may be a one (1) to 30 (thirty) atom chain, may be branched or unbranched, contains carbon, oxygen, and/or nitrogen atoms, may be saturated or unsaturated and, apart from polyfluorinated moieties, may be substituted or unsubstituted. To show the fluorine-fluorine affinity interaction, FIG. 1 shows a first polyfluorinated moiety 114 (indicated by an F in a circle) and a second polyfluorinated moiety 116 (also indicated by an F in a circle) of polyfluorinated linker 104. Polyfluorinated moieties 114 and 116 may each be a part of chain Y and may independently be any suitable polyfluorinated moiety, such as —CF₃, —CF₂—, or —CF₂—CF₂—. While FIG. 1 shows two polyfluorinated moieties (e.g., a bi-functional polyfluorinated linker), polyfluorinated linker 104 (e.g., chain Y) may include any other number of polyfluorinated moieties (e.g., one or three or more) (e.g., polyfluorinated linker 104 may be a mono-functional polyfluorinated linker or a tri-functional polyfluorinated linker).

When polyfluorinated polymer 102 and polyfluorinated linker 104 are combined, polyfluorinated moiety 112 and polyfluorinated moiety 114 bind together by a fluorine-fluorine affinity interaction, thereby producing polyfluorinated linker-modified polymer 106. Since fluorine is both hydrophobic and lipophobic, the fluorine-fluorine affinity interaction is stable in water and other polar solvents that may be used in an electrochemical cell. The degree of modification of polyfluorinated polymer 102 may be controlled by controlling the amount (e.g., the stoichiometric ratio) of polyfluorinated linker 104 that is combined with polyfluorinated polymer 102. The amount of polyfluorinated linker 104 that is used may also be controlled to achieve the desired hydrophobic/hydrophilic characteristics of polyfluorinated linker-modified polymer 106. Scheme 100 may be used to produce efficient PEMs for use in fuel cells and/or efficient ionomers for use in catalyst layers.

FIG. 2 shows an illustrative scheme 200 for binding a first polyfluorinated polymer to a second polyfluorinated polymer by way of a polyfluorinated linker. FIG. 2 is similar to FIG. 1 except that, in FIG. 2, a second polyfluorinated polymer 202 also binds with polyfluorinated linker 104 to produce a polymer-linker-modified polyfluorinated polymer 204. Second polyfluorinated polymer 202 may be, for example, an ionomer or a membrane (e.g., a PEM) and may be implemented by any polyfluorinated polymer described herein, and may be the same as, similar to, or different than polyfluorinated polymer 102. Second polyfluorinated polymer 202 includes a main chain 206 and a polyfluorinated side-chain 208 comprising a chain A and a pendant acid group X. Chain A and pendant acid group X of side-chain 208 may be as described herein but need not be the same as chain A and pendant acid group X of side-chain 110. To show the fluorine-fluorine affinity interaction, FIG. 2 shows a polyfluorinated moiety 210 (indicated by an F in a circle). Polyfluorinated moiety 210 may be a part of chain A and may be any suitable polyfluorinated moiety described herein. While FIG. 2 shows only one polyfluorinated moiety 210, side-chain 208 (e.g., chain A) may include any other number of polyfluorinated moieties. Furthermore, although not shown in FIG. 2, main chain 206 may include one or more polyfluorinated moieties.

In a first step, polyfluorinated polymer 102 and polyfluorinated linker 104 are combined as in scheme 100 to produce polyfluorinated linker-modified polymer 106. In a second step, second polyfluorinated polymer 202 is combined with polyfluorinated linker 104 of polyfluorinated linker-modified polymer 106 so that polyfluorinated moiety 210 and polyfluorinated moiety 116 bind together by a fluorine-fluorine affinity interaction, thereby producing polymer-linker-modified polyfluorinated polymer 204. Alternatively to a multi-step process, scheme 200 may be performed in a one-pot process by combining all reagents at substantially the same time.

In some examples, scheme 200 may be used to produce a porous polymer network that may be used as a membrane (e.g., a PEM) or as an ionomer for use in catalyst layers. In other examples, polyfluorinated polymer 102 is a polyfluorinated polymer (e.g., PEM) and second polyfluorinated polymer 202 is a polyfluorinated ionomer of a catalyst layer, thereby binding the catalyst layer to the PEM.

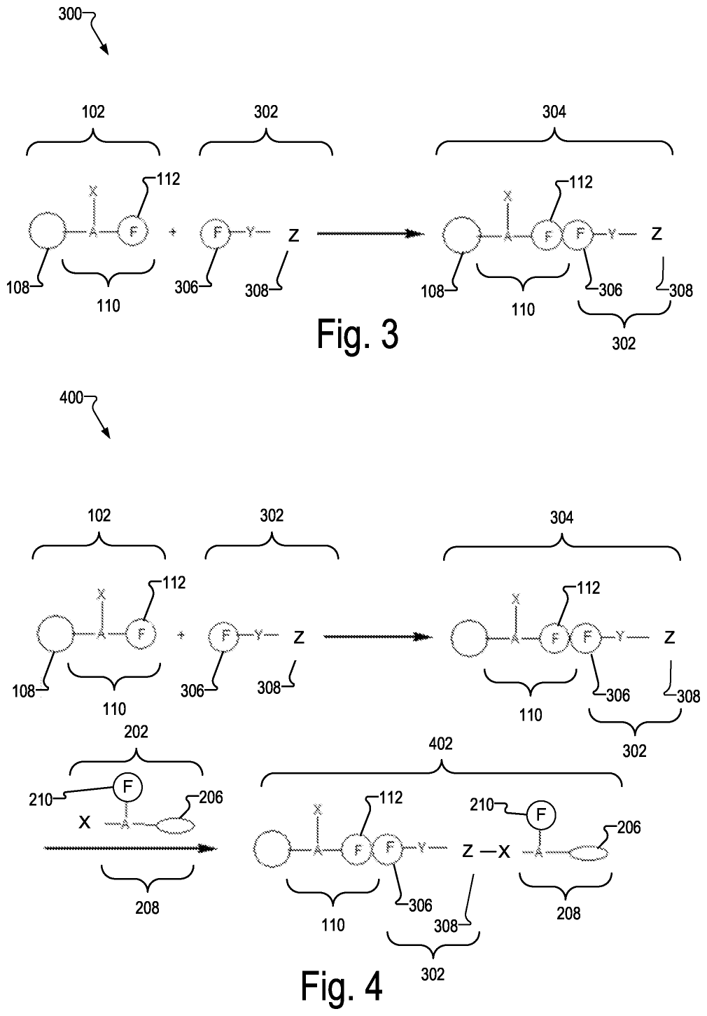

FIG. 3 shows another illustrative scheme 300 for surface modification of a polyfluorinated polymer surfaces using a polyfluorinated linker. FIG. 3 is similar to FIG. 1 except that scheme 300 uses bi-functional polyfluorinated linker 302 instead of polyfluorinated linker 104 to produce a polyfluorinated linker-modified polymer 304. Bi-functional polyfluorinated linker 302 is represented by alkyl chain Y and may be any bi-functional polyfluorinated linker described herein. To show the fluorine-fluorine affinity interaction, FIG. 3 shows a polyfluorinated moiety 306 (indicated by an F in a circle) (the first linking group). Polyfluorinated moiety 306 may be a part of chain Y and may be any suitable polyfluorinated moiety described herein. Bi-functional polyfluorinated linker 302 also includes a second linking group 308 (indicated by a Z), which may or may not be a part of chain Y. Second linking group 308 may be any non-polyfluorinated linking group described herein (e.g., a tertiary amino group (—NR₃), an alkoxy or aryloxy group (RO—), a hydroxyl group (—OH), or an acid group (e.g., a carboxylic acid group (—COOH), a sulfonic acid group (—SO₃H), a phosphoric acid group, a phosphonic acid group, a phosphate group, a boronic acid group, etc.).

When polyfluorinated polymer 102 and bi-functional polyfluorinated linker 302 are combined, first polyfluorinated moiety 112 and polyfluorinated moiety 306 bind together by a fluorine-fluorine affinity interaction, thereby producing polyfluorinated linker-modified polymer 304. Scheme 100 may be used to produce efficient PEMs for use in fuel cells and/or efficient ionomers for use in catalyst layers. Polyfluorinated linker-modified polymer 304 may be used as-is, or it may undergo further reaction to bind with another polymer or a catalyst, as will be described below.

FIG. 4 shows an illustrative scheme 400 for binding a first polyfluorinated polymer to a second polyfluorinated polymer by way of a bi-functional polyfluorinated linker. Scheme 400 is similar to scheme 200 except that scheme 400 uses bi-functional polyfluorinated linker 302 of scheme 300. In a first step, polyfluorinated polymer 102 and bi-functional polyfluorinated linker 302 are combined as in scheme 300 to produce polyfluorinated linker-modified polymer 304. In a second step, polyfluorinated linker-modified polymer 304 is combined with second polyfluorinated polymer 202. Pendant linking group X and second linking group 308 covalently bond, thereby producing polymer-linker-modified polymer 402. Alternatively to a multi-step process, scheme 200 may be performed in a one-pot process by combining all reagents together at substantially the same time.

In some examples, scheme 400 may be used to produce a porous polymer network that may be used as a membrane (e.g., a PEM) or as an ionomer for use in catalyst layers. In other examples, polyfluorinated polymer 102 is a polyfluorinated polymer (e.g., PEM) and second polyfluorinated polymer 202 is a polyfluorinated ionomer of a catalyst layer, thereby binding the catalyst layer to the PEM. Scheme 400 may be used to control proton migration and conductivity of the PEM. By bonding second polyfluorinated polymer 202 to bi-functional polyfluorinated linker 302 through the pendant acid group X of second polyfluorinated polymer 202, proton migration may be restricted or reduced.

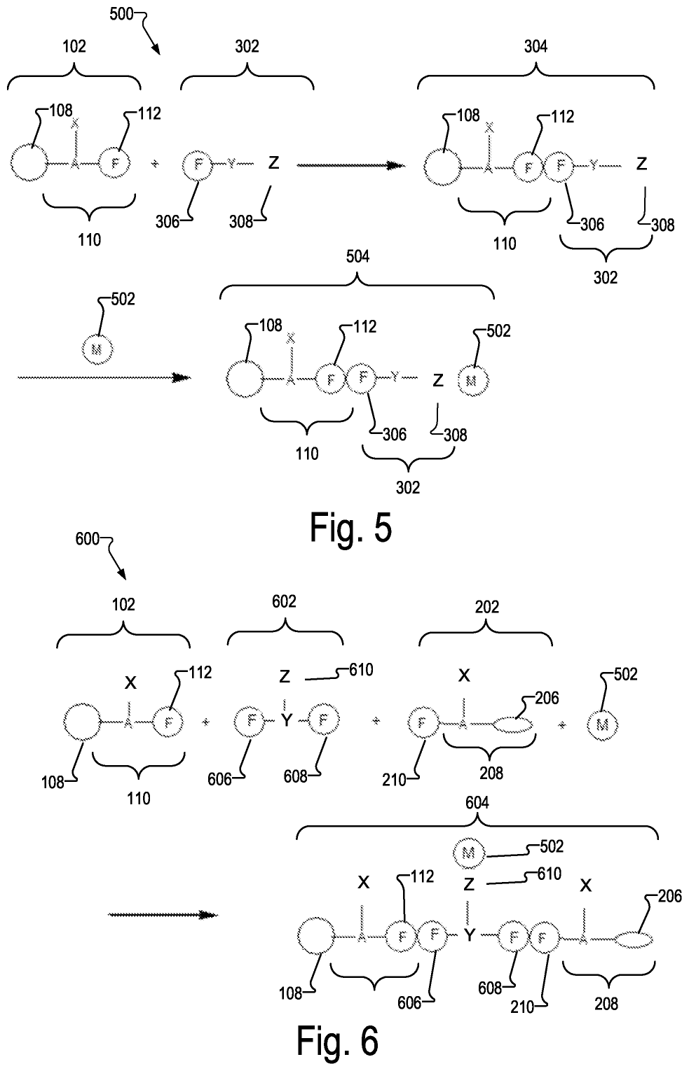

FIG. 5 shows an illustrative scheme 500 for binding a metal catalyst with a polyfluorinated polymer (e.g., an ionomer). In scheme 500, polyfluorinated linker-modified polymer 304 (produced by scheme 300) is combined with a catalyst 502 (indicated by an M in a circle) to produce a catalyst-linker-modified polymer 504. Catalyst 502 may be any catalyst described herein. Catalyst 502 has affinity to oxygen and/or nitrogen ligands of second linking group 308 of bi-functional polyfluorinated linker 302, thereby strongly maintaining the catalyst 502 in proximity to polyfluorinated polymer 102 and thereby reducing or preventing migration of catalyst 502. In some examples, polyfluorinated polymer 102 is an ionomer and catalyst-linker-modified polymer 504 is used as or in a catalyst layer.

FIG. 6 shows an illustrative scheme 600 for binding a first polyfluorinated polymer, a second polyfluorinated polymer, and a catalyst using a tri-functional polyfluorinated linker to produce a catalyst-coated membrane. As shown in FIG. 6, first polyfluorinated polymer 102, a tri-functional polyfluorinated linker 602, second polyfluorinated polymer 202, and catalyst 502 are combined in a one-pot process to produce a catalyst-coated membrane 604. First polyfluorinated polymer 102 may be a polyfluorinated ionomer and second polyfluorinated polymer 202 may be a PEM. Tri-functional polyfluorinated linker 602 is represented by alkyl chain Y and may be any tri-functional polyfluorinated linker described herein. To show the fluorine-fluorine affinity interaction, FIG. 6 shows a first linking group 606 (a polyfluorinated moiety indicated by an F in a circle), a second linking group 608 (a polyfluorinated moiety indicated by an F in a circle), and a third linking group 610 (indicated by a Z). First linking group 606 and second linking group 608 may be a part of chain Y and may be any suitable polyfluorinated moiety described herein. Third linking group 610 may or may not be a part of chain Y and may be any non-polyfluorinated linking group described herein (e.g., a tertiary amino group (—NR₃), an alkoxy or aryloxy group (RO—), a hydroxyl group (—OH), or an acid group (e.g., a carboxylic acid group (—COOH), a sulfonic acid group (—SO₃H), a phosphoric acid group, a phosphonic acid group, a phosphate group, a boronic acid group, etc.).

When first polyfluorinated polymer 102, second polyfluorinated polymer 202, catalyst 502, and tri-functional polyfluorinated linker 602 are combined, first polyfluorinated moiety 112 and first linking group 606 bind together by a fluorine-fluorine affinity interaction, polyfluorinated moiety 210 and second linking group 608 bind together by a fluorine-fluorine affinity interaction, and catalyst 502 and third linking group 610 bind together, thereby producing catalyst-coated membrane 604. In some alternative examples, second linking group 608 is a non-polyfluorinated linking group (e.g., similar to or the same as third linking group 610), and second polyfluorinated polymer 202 (pendant acid group X) covalently binds with second linking group 608 of tri-functional polyfluorinated linker 602.

While scheme 600 is described as a one-pot process, scheme 600 may alternatively be performed in a multi-step process. For example, a catalyst ink comprising a colloidal suspension of first polyfluorinated polymer 102 (e.g., an ionomer), tri-functional polyfluorinated linker 602, and catalyst 502 may be formed in a first step, and the catalyst ink may be sprayed onto second polyfluorinated polymer 202 (e.g., a PEM) in a second step. As another example, tri-functional polyfluorinated linker 602 and catalyst 502 may be combined in a first step, then combined with first polyfluorinated polymer 102 in a second step to form a catalyst ink suspension, and then the catalyst ink suspension may be sprayed onto second polyfluorinated polymer 202 in a third step.

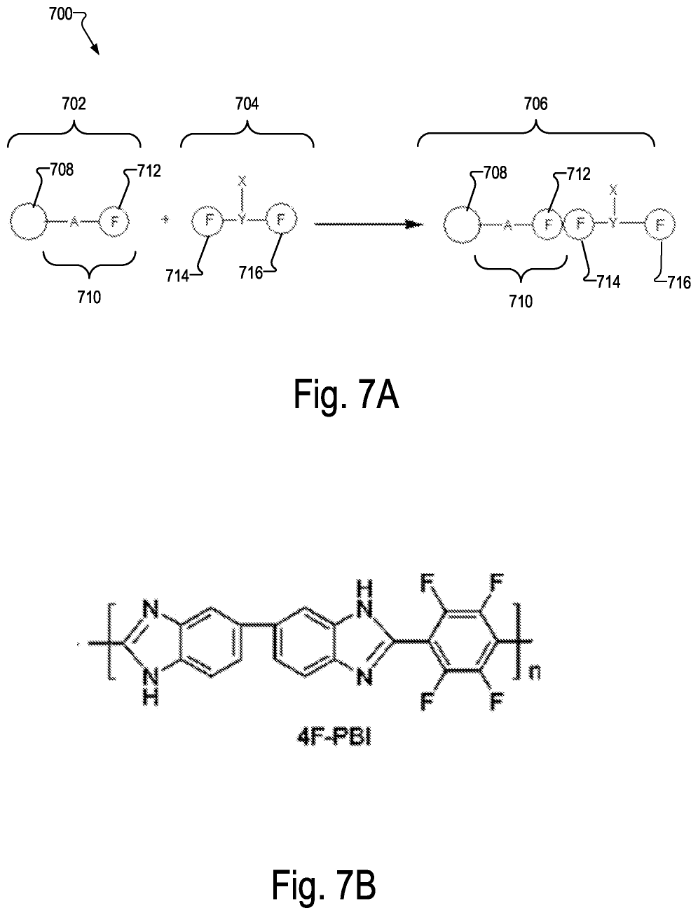

FIG. 7A shows an illustrative scheme 700 for modification of an unfunctionalized polyfluorinated polymer into an acid-functionalized polymer with a pendant acid group. In scheme 700, an unfunctionalized polyfluorinated polymer 702 is combined with an acid-functionalized polyfluorinated linker 704 to form an acid-functionalized polymer 706.

Unfunctionalized polyfluorinated polymer 702 includes a main chain 708 and a polyfluorinated side-chain 710 comprising a chain A. Chain A has one (1) to 30 (thirty) atoms, may be branched or unbranched, contains carbon, oxygen, and/or nitrogen atoms, may be saturated or unsaturated and, apart from polyfluorinated moieties, may be substituted or unsubstituted. To show the fluorine-fluorine affinity interaction, FIG. 7A shows a polyfluorinated moiety 712 (indicated by an F in a circle). Polyfluorinated moiety 712 may be a part of chain A and may be any suitable polyfluorinated moiety described herein. While FIG. 7A shows only one polyfluorinated moiety 712, side-chain 710 (e.g., chain A) may include any other number of polyfluorinated moieties. Furthermore, although not shown in FIG. 7A, main chain 708 may include one or more polyfluorinated moieties. In some examples, side chain 710 is omitted from unfunctionalized polyfluorinated polymer 702 provided that main chain 708 is polyfluorinated. Unfunctionalized polyfluorinated polymer 702 may be any unfunctionalized polyfluorinated polymer described herein, such as polytetrafluorethylene (PTFE), a polyfluorinated polybenzimidazole (PBI) polymer (e.g., 4F-PBI), and/or polytrifluorostyrene. Unfunctionalized polyfluorinated polymer 702 may be in any form, such as a resin bead, a membrane, or a porous polymer network.

FIG. 7B shows the general structure of 4F-PBI, which may be used as unfunctionalized polyfluorinated polymer 702. 4F-PBI includes a tetrafluorobenzene moiety within the main chain that may link, by way of the fluorine-fluorine affinity interaction, with polyfluorinated moiety 714 of polyfluorinated linker 704.

Referring again to FIG. 7A, acid-functionalized polyfluorinated linker 704 is represented by alkyl chain Y with a pendant acid group X. Pendant acid group X is any pendant acid group described herein. To show the fluorine-fluorine affinity interaction, FIG. 7A shows a first polyfluorinated moiety 714 (indicated by an F in a circle) and a second polyfluorinated moiety 716 (indicated by an F in a circle). First polyfluorinated moiety 714 and second polyfluorinated moiety 716 may be a part of chain Y and may be any suitable polyfluorinated moiety described herein. Polyfluorinated linker 704 may also include one or more other linking groups (not shown), which may or may not be a part of chain Y.

When unfunctionalized polyfluorinated polymer 702 is combined with acid-functionalized polyfluorinated linker 704, polyfluorinated moiety 712 and polyfluorinated moiety 714 bind by the fluorine-fluorine affinity interaction, thereby forming acid-functionalized polymer 706. Scheme 700 may be used to form an acid-functionalized polymer with controlled loading of pendant acid group X. In this way, a pendant acid group may be easily added to an unfunctionalized polymer with strong binding by way of the fluorine-fluorine affinity interaction. Acid-functionalized polymer 706 may be used in any suitable way, such as an ionomer, a membrane (e.g., PEM), or as a polyfluorinated polymer in any of schemes 100 to 600 described above in FIGS. 1 to 6.

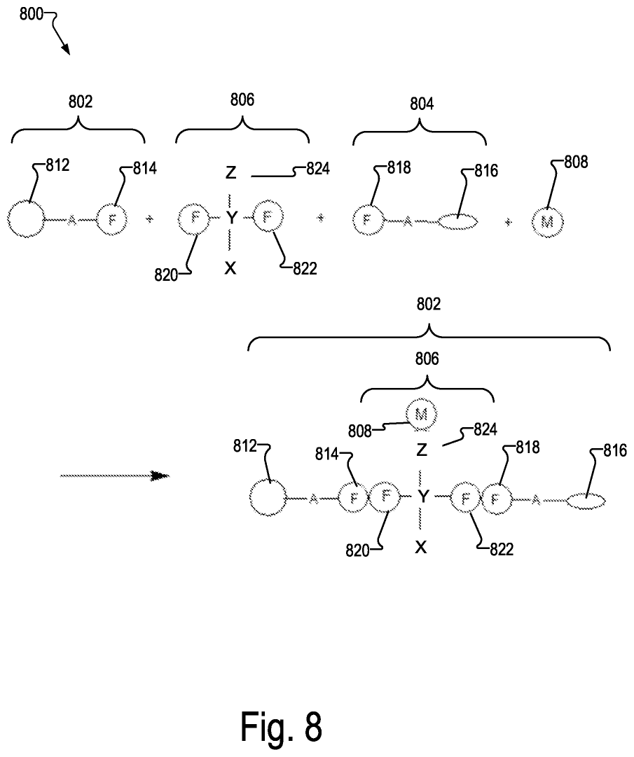

FIG. 8 shows an illustrative scheme 800 for formation of a catalyst-coated proton-exchange membrane using an unfunctionalized polyfluorinated polymer. As shown in FIG. 8, a first unfunctionalized polyfluorinated polymer 802, a second unfunctionalized polyfluorinated polymer 804, an acid-functionalized polyfluorinated linker 806, and a catalyst 808 are combined to produce a catalyst-coated membrane 810.

First unfunctionalized polyfluorinated polymer 802 is the same as or similar to unfunctionalized polyfluorinated polymer 702 described above and includes a main chain 812 and a side chain A including a polyfluorinated moiety 814. Second unfunctionalized polyfluorinated polymer 804 is the same as or similar to unfunctionalized polyfluorinated polymer 702 described above and includes a main chain 816 and a side chain A including a polyfluorinated moiety 818. First unfunctionalized polyfluorinated polymer 802 may be a polyfluorinated ionomer and second unfunctionalized polyfluorinated polymer 804 may be a PEM and may be the same as or different from one another.

Acid-functionalized polyfluorinated linker 806 is represented by alkyl chain Y with a pendant acid group X and is tri-functional (e.g., includes three linking groups). Pendant acid group X is any pendant acid group described herein. To show the fluorine-fluorine affinity interaction, FIG. 8 shows a first linking group 820 (a polyfluorinated moiety indicated by an F in a circle), a second linking group 822 (a polyfluorinated moiety indicated by an F in a circle), and a third linking group 824 (indicated by a Z). First linking group 820 and second linking group 822 may be a part of chain Y and may be any suitable polyfluorinated moiety described herein. Third linking group 824 may or may not be a part of chain Y and may be any non-polyfluorinated linking group described herein (e.g., a tertiary amino group (—NR₃), an alkoxy or aryloxy group (RO—), a hydroxyl group (—OH), or an acid group (e.g., a carboxylic acid group (—COOH), a sulfonic acid group (—SO₃H), a phosphoric acid group, a phosphonic acid group, a phosphate group, a boronic acid group, etc.).

When the reagents are combined, polyfluorinated moiety 814 and first linking group 820 bind together by a fluorine-fluorine affinity interaction, polyfluorinated moiety 818 and second linking group 822 bind together by a fluorine-fluorine affinity interaction, and catalyst 808 and third linking group 824 bind together, thereby producing catalyst-coated membrane 810 with a pendant acid group X.

In some examples, catalyst-coated membrane 810 may be formed in a one-pot process by combining all reagents together at substantially the same time. Alternatively, catalyst-coated membrane 810 may be formed in a multi-step process. For example, a catalyst ink comprising a colloidal suspension of first unfunctionalized polyfluorinated polymer 802 (e.g., an ionomer), acid-functionalized polyfluorinated linker 806, and catalyst 808 may be formed in a first step. The catalyst ink may then be sprayed onto second unfunctionalized polyfluorinated polymer 804 (e.g., a PEM) in a second step. As another example, acid-functionalized polyfluorinated linker 806 and catalyst 808 may be combined in a first step, then combined with first unfunctionalized polyfluorinated polymer 802 in a second step to form a catalyst ink colloidal suspension. The catalyst ink may then be sprayed onto second unfunctionalized polyfluorinated polymer 804 in a third step.

Various modifications may be made to the examples described above. For example, a polyfluorinated boron-based compound may be used in place of a polyfluorinated organic compound. A polyfluorinated boron-based compound may include multiple B—F bonds. For example, tetravalent boron compounds, including those described in International Patent Application No. PCT/US2021/029705 and International Patent Application No. PCT/US2021/038956, may be used in addition to, or in place of, the polyfluorinated compounds described herein.

In further examples, organic and inorganic non-polyfluorinated compounds that have been functionalized with polyfluorinated tags or polyfluorinated ponytails may be used in place of a polyfluorinated polymer. Such non-polyfluorinated compounds may include, without limitation, amorphous inorganic materials (e.g., glass, fused silica, or ceramics), crystalline inorganic materials (e.g., quartz, single crystal silicon, or alumina), non-polyfluorinated synthetic polymers, and non-polyfluorinated natural polymers (e.g., lignin, cellulose, chitin, etc.). In some examples, the polyfluorinated tag or polyfluorinated ponytail is a polyfluorinated linker described herein.

The polyfluorinated linker-modified compositions and apparatuses described herein may be used in PEMs, catalyst layers, ionomers, and catalyst-coated membranes of electrochemical cells, such as water electrolysis systems and fuel cell systems.

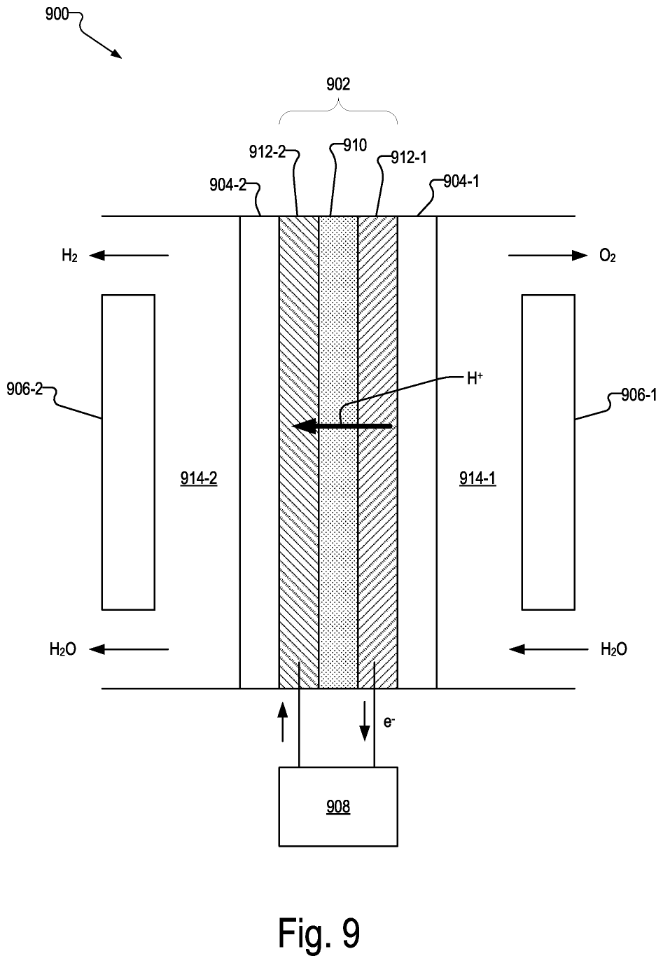

FIG. 9 shows an illustrative proton exchange membrane water electrolysis system 900 (PEM water electrolysis system 900) incorporating polyfluorinated linker-modified polymers. PEM water electrolysis system 900 uses electricity to split water into oxygen (O₂) and hydrogen (H₂) via an electrochemical reaction. The configuration of PEM water electrolysis system 900 is merely illustrative and not limiting, as other suitable configurations as well as other suitable water electrolysis systems may incorporate polyfluorinated linker-modified porous polymers.

As shown in FIG. 9, PEM water electrolysis system 900 includes a membrane electrode assembly 902 (MEA 902), porous transport layers 904-1 and 904-2, bipolar plates 906-1 and 906-2, and an electrical power supply 908. PEM water electrolysis system 900 may also include additional or alternative components not shown in FIG. 9 as may serve a particular implementation.

MEA 902 includes a PEM 910 positioned between a first catalyst layer 912-1 and a second catalyst layer 912-2. PEM 910 electrically isolates first catalyst layer 912-1 from second catalyst layer 912-2 while providing selective conductivity of cations, such as protons (H⁺), and while being impermeable to gases such as hydrogen and oxygen. PEM 910 may be implemented by any suitable PEM. For example, PEM 910 may be implemented by a polyfluorinated linker-modified porous membrane comprising a porous structural framework with polyfluorinated linkers bound by the fluorine-fluorine affinity interaction to pore surfaces within the porous structural framework.

First catalyst layer 912-1 and second catalyst layer 912-2 are electrically conductive electrodes with embedded electrochemical catalysts (not shown), such as platinum, ruthenium, and/or or cerium(IV) oxide. In some examples, first catalyst layer 912-1 and second catalyst layer 912-2 are formed using an ionomer to bind catalyst nanoparticles. In some examples, the ionomer used to form first catalyst layer 912-1 and second catalyst layer 912-2 includes a polyfluorinated linker-modified polymer as described herein. In some examples, first catalyst layer 912-1 and/or second catalyst layer 912-2 is bound to PEM 910 by a polyfluorinated linker by the fluorine-fluorine affinity interaction.

MEA 902 is placed between porous transport layers 904-1 and 904-2, which are in turn placed between bipolar plates 906-1 and 906-2 with flow channels 914-1 and 914-2 located in between bipolar plates 906 and porous transport layers 904.

In MEA 902, first catalyst layer 912-1 functions as an anode and second catalyst layer 912-2 functions as a cathode. When PEM water electrolysis system 900 is powered by power supply 908, an oxygen evolution reaction (OER) occurs at anode 912-1, represented by the following electrochemical half-reaction:

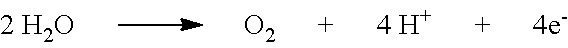

Protons are conducted from anode 912-1 to cathode 912-2 through PEM 910, and electrons are conducted from anode 912-1 to cathode 912-2 by conductive path around PEM 910. PEM 910 allows for the transport of protons (H⁺) and water from the anode 912-1 to the cathode 912-2 but is impermeable to oxygen and hydrogen. At cathode 912-2, the protons combine with the electrons in a hydrogen evolution reaction (HER), represented by the following electrochemical half-reaction:

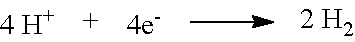

The OER and HER are two complementary electrochemical reactions for splitting water by electrolysis, represented by the following overall water electrolysis reaction:

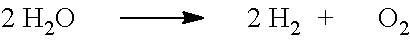

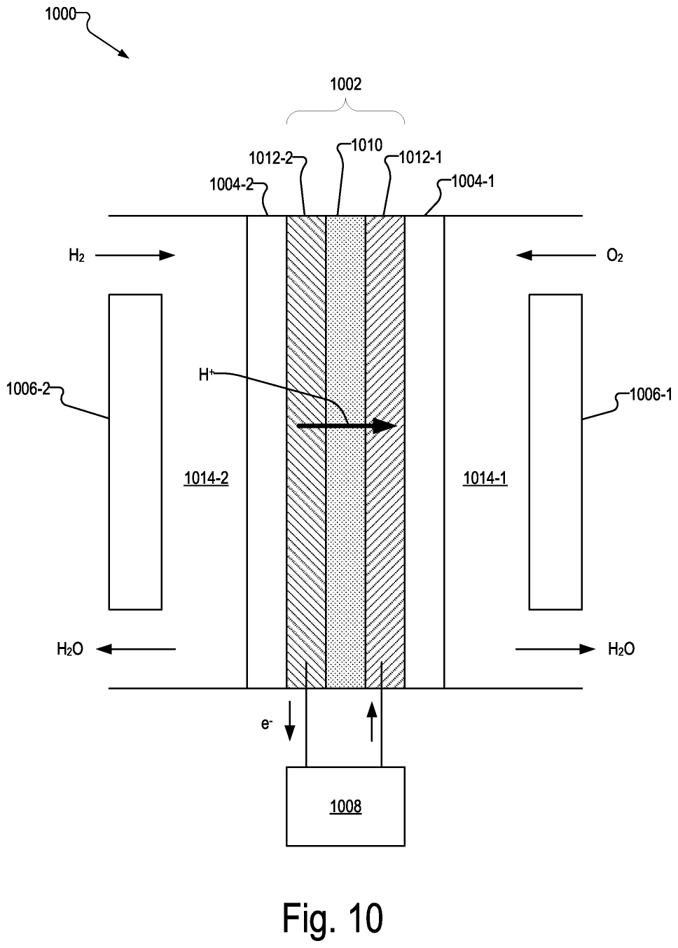

FIG. 10 shows an illustrative proton exchange membrane fuel cell 1000 (PEM fuel cell 1000) including polyfluorinated linker-modified polymers. PEM fuel cell 1000 produces electricity as a result of electrochemical reactions. In this example, the electrochemical reactions involve reacting hydrogen gas (H₂) and oxygen gas (O₂) to produce water and electricity. The configuration of PEM fuel cell 1000 is merely illustrative and not limiting, as other suitable configurations as well as other suitable proton exchange membrane fuel cells may incorporate polyfluorinated linker-modified porous polymers.

As shown in FIG. 10, PEM fuel cell 1000 includes a membrane electrode assembly 1002 (MEA 1002), porous transport layers 1004-1 and 1004-2, bipolar plates 1006-1 and 1006-2. An electrical load 1008 may be electrically connected to MEA 1002 and driven by PEM fuel cell 1000. PEM fuel cell 1000 may also include additional or alternative components not shown in FIG. 10 as may serve a particular implementation.

MEA 1002 includes a PEM 1010 positioned between a first catalyst layer 1012-1 and a second catalyst layer 1012-2. PEM 1010 electrically isolates first catalyst layer 1012-1 from second catalyst layer 1012-2 while providing selective conductivity of cations, such as protons (H⁺), and while being impermeable to gases such as hydrogen and oxygen. PEM 1010 may be implemented by any suitable PEM. For example, PEM 1010 may be implemented by a polyfluorinated linker-modified porous membrane comprising a porous structural framework with polyfluorinated linkers bound by the fluorine-fluorine affinity interaction to pore surfaces within the porous structural framework.

First catalyst layer 1012-1 and second catalyst layer 1012-2 are electrically conductive electrodes with embedded electrochemical catalysts (not shown). In some examples, first catalyst layer 1012-1 and second catalyst layer 1012-2 are formed using an ionomer to bind catalyst nanoparticles. In some examples, the ionomer used to form first catalyst layer 1012-1 and second catalyst layer 1004-2 includes a polyfluorinated linker-modified polymer as described herein. In some examples, first catalyst layer 1012-1 and/or second catalyst layer 1012-2 is bound to PEM 1010 by a polyfluorinated linker by the fluorine-fluorine affinity interaction.

MEA 1002 is placed between porous transport layers 1004-1 and 1004-2, which are in turn placed between bipolar plates 1006-1 and 1006-2 with flow channels 1014 located in between. In MEA 1002, first catalyst layer 1012-1 functions as a cathode and second catalyst layer 1012-2 functions as an anode. Cathode 1012-1 and anode 1012-2 are electrically connected to load 1008, and electricity generated by PEM fuel cell 1000 drives load 1008.

During operation of PEM fuel cell 1000, hydrogen gas (H₂) flows into the anode side of PEM fuel cell 1000 and oxygen gas (O₂) flows into the cathode side of PEM fuel cell 1000. At anode 1012-2, hydrogen molecules are catalytically split into protons (H⁺) and electrons (e⁻) according to the following hydrogen oxidation reaction (HOR):

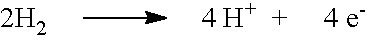

The protons are conducted from anode 1012-2 to cathode 1012-1 through PEM 1000, and the electrons are conducted from anode 1012-2 to cathode 1012-1 around PEM 1010 through a conductive path and load 1008. At cathode 1012-1, the protons and electrons combine with the oxygen gas according to the following oxygen reduction reaction (ORR):

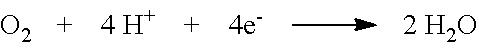

Thus, the overall electrochemical reaction for the PEM fuel cell 1000 is:

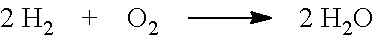

In the overall reaction, PEM fuel cell 1000 produces water at cathode 1012-1. Water may flow from cathode 1012-1 to anode 1012-2 through PEM 1010 and may be removed through outlets at the cathode side and/or anode side of PEM fuel cell 1000. The overall reaction generates electrons at the anode that drive load 1008.

In the preceding description, various exemplary embodiments have been described with reference to the accompanying drawings. It will, however, be evident that various modifications and changes may be made thereto, and additional embodiments may be implemented, without departing from the scope of the claims that follow. For example, certain features of one embodiment described herein may be combined with or substituted for features of another embodiment described herein. The description and drawings are accordingly to be regarded in an illustrative rather than a restrictive sense.

Advantages and features of the present disclosure can be further described by the following examples:

Example 1. A membrane electrode assembly comprising: a polyfluorinated polymer; and a polyfluorinated linker bound to the polyfluorinated polymer by a fluorine-fluorine affinity interaction.

Example 2. The membrane electrode assembly of example 1, wherein the polyfluorinated polymer comprises a side chain comprising an alkyl chain of one to thirty atoms and optionally has one or more pendant moieties, which may be the same or different for each atom in the side chain and which may comprise hydrogen, a hydroxyl group, a fluoro group, a chloro group, a dialkylamino group, a cyano group, a carboxylic acid group, a carboxylic amide group, an ester group, an alkyl group, an alkoxy group, or an aryl group.

Example 3. The membrane electrode assembly of example 1 or 2, further comprising a polyfluorinated ionomer bound to the polyfluorinated linker.

Example 4. The membrane electrode assembly of example 3, wherein the polyfluorinated ionomer is bound to the polyfluorinated linker by an additional fluorine-fluorine affinity interaction.

Example 5. The membrane electrode assembly of example 3, wherein: the polyfluorinated linker further comprises a linking group comprising a tertiary amino group, an alkoxy group, an aryloxy group, a hydroxyl group, an acid group, or a derivative of any of the foregoing; and the polyfluorinated ionomer is bound to the polyfluorinated linker by the linking group.

Example 6. The membrane electrode assembly of example 5, wherein the polyfluorinated ionomer is bound to the linking group of the polyfluorinated linker by a pendant acid group of the polyfluorinated ionomer.

Example 7. The membrane electrode assembly of any of the preceding examples, wherein the polyfluorinated linker further comprises a linking group comprising a tertiary amino group, an alkoxy group, an aryloxy group, a hydroxyl group, an acid group, or a derivative of any of the foregoing.

Example 8. The membrane electrode assembly of example 7, further comprising a catalyst bound to the polyfluorinated linker at the linking group.

Example 9. The membrane electrode assembly of example 8, further comprising a polyfluorinated ionomer bound to the polyfluorinated linker.

Example 10. The membrane electrode assembly of example 9, wherein the polyfluorinated ionomer is bound to the polyfluorinated linker by an additional fluorine-fluorine affinity interaction.

Example 11. The membrane electrode assembly of any of the preceding examples, wherein the polyfluorinated linker comprises a polyfluorinated chain comprising one to thirty atoms.

Example 12. The membrane electrode assembly of example 11, wherein the polyfluorinated linker further comprises a pendant acid group.

Example 13. The membrane electrode assembly of example 12, wherein the pendant acid group comprises a tetravalent boron-based acid group.

Example 14. The membrane electrode assembly of any of the preceding examples, wherein the polyfluorinated polymer comprises an unfunctionalized polyfluorinated polymer.

Example 15. The membrane electrode assembly of example 14, wherein the unfunctionalized polyfluorinated polymer comprises polytetrafluoroethylene.

Example 16. The membrane electrode assembly of example 14, wherein the unfunctionalized polyfluorinated polymer comprises 4F-PBI.

Example 17. The membrane electrode assembly of any one of examples 1 to 13, wherein the polyfluorinated polymer comprises a pendant acid group.

Example 18. The membrane electrode assembly of example 17, wherein the pendant acid group comprises a tetravalent boron-based acid group.

Example 19. The membrane electrode assembly of any one of examples 1 to 13, wherein the polyfluorinated polymer comprises a proton exchange membrane.

Example 20. The membrane electrode assembly of any one of examples 1 to 13, wherein the polyfluorinated polymer comprises an ionomer.

Example 21. A method of making a membrane electrode assembly, comprising: binding a polyfluorinated linker with a polyfluorinated polymer by a fluorine-fluorine affinity interaction.

Example 22. The method of example 21, wherein the polyfluorinated polymer comprises a side chain comprising an alkyl chain of one to thirty atoms and optionally has one or more pendant moieties, which may be the same or different for each atom in the side chain and which may comprise hydrogen, a hydroxyl group, a fluoro group, a chloro group, a dialkylamino group, a cyano group, a carboxylic acid group, a carboxylic amide group, an ester group, an alkyl group, an alkoxy group, or an aryl group.

Example 23. The method of example 21 or 22, further comprising binding a polyfluorinated ionomer to the polyfluorinated linker.

Example 24. The method of example 23, wherein the polyfluorinated ionomer is bound to the polyfluorinated linker by an additional fluorine-fluorine affinity interaction.

Example 25. The method of example 24, wherein: the polyfluorinated linker further comprises a linking group comprising a tertiary amino group, an alkoxy group, an aryloxy group, a hydroxyl group, an acid group, or a derivative of any of the foregoing; and the polyfluorinated ionomer is bound to the polyfluorinated linker by the linking group.

Example 26. The method of example 25, wherein the polyfluorinated ionomer is bound to the polyfluorinated linker by a pendant acid group of the polyfluorinated ionomer.

Example 27. The method of any one of examples 21 to 26, wherein the polyfluorinated linker further comprises a linking group comprising a tertiary amino group, an alkoxy group, an aryloxy group, a hydroxyl group, an acid group, or a derivative of any of the foregoing.

Example 28. The method of example 27, further comprising binding a catalyst to the polyfluorinated linker at the linking group.

Example 29. The method of example 28, wherein the binding the polyfluorinated linker with the polyfluorinated polymer, the binding the polyfluorinated ionomer to the polyfluorinated linker, and the binding the catalyst to the polyfluorinated linker are performed in a one-pot process.

Example 30. The method of example 28, further comprising: forming a colloidal suspension comprising the polyfluorinated ionomer bound to the polyfluorinated linker and the catalyst bound to the polyfluorinated linker; and spraying the colloidal suspension onto the polyfluorinated polymer.

Example 31. The method of example 28, further comprising binding a polyfluorinated ionomer to the polyfluorinated linker.

Example 32. The method of example 30, wherein the polyfluorinated ionomer is bound to the polyfluorinated linker by an additional fluorine-fluorine affinity interaction.

Example 33. The method of any one of examples 21 to 32, wherein the polyfluorinated linker comprises a polyfluorinated chain comprising one to thirty atoms.

Example 34. The method of example 33, wherein the polyfluorinated linker further comprises a pendant acid group.

Example 35. The method of example 34, wherein the pendant acid group comprises a tetravalent boron-based acid group.

Example 36. The method of any one of examples 21 to 35, wherein the polyfluorinated polymer comprises an unfunctionalized polyfluorinated polymer.

Example 37. The method of example 36, wherein the unfunctionalized polyfluorinated polymer comprises polytetrafluoroethylene.

Example 38. The method of example 36, wherein the unfunctionalized polyfluorinated polymer comprises 4F-PBI.

Example 39. The method of any one of examples 21 to 35, wherein the polyfluorinated polymer comprises a pendant acid group.

Example 40. The method of example 39, wherein the pendant acid group comprises a tetravalent boron-based acid group.

Example 41. The method of any one of examples 21 to 35, wherein the polyfluorinated polymer comprises a proton exchange membrane.

Example 42. The method of any one of examples 21 to 35, wherein the polyfluorinated polymer comprises an ionomer.

Example 43. A method of making a catalyst-coated membrane, comprising: combining a polyfluorinated polymer, a polyfluorinated linker, a polyfluorinated ionomer, and a catalyst in a one-pot process.

Example 44. The method of example 43, wherein the polyfluorinated polymer comprises a polyfluorosulfonic acid polymer.

Example 45. The method of example 43 or 44, wherein the polyfluorinated linker comprises a polyfluorinated chain of one to thirty atoms.

Example 46. The method of example 43, wherein the polyfluorinated polymer is unfunctionalized and the polyfluorinated linker further comprises a pendant acid group.

Example 47. The method of example 46, wherein the pendant acid group comprises a tetravalent boron-based acid group.

Example 48. The method of example 46, wherein the polyfluorinated polymer comprises polytetrafluoroethylene.

Example 49. The method of example 46, wherein the polyfluorinated polymer comprises 4F-PBI.

Example 50. The method of example 43, wherein the polyfluorinated polymer comprises a pendant acid group.

Example 51. The method of example 50, wherein the pendant acid group comprises a tetravalent boron-based acid group.

Example 52. The method of example 43, wherein the polyfluorinated polymer comprises a proton exchange membrane.

Example 53. The method of example 43, wherein the polyfluorinated polymer comprises an ionomer.

Example 54. A method of making a membrane electrode assembly, comprising: binding an acid-unfunctionalized polyfluorinated polymer with an acid-functionalized polyfluorinated linker by a fluorine-fluorine affinity interaction.

Example 55. The method of example 54, wherein the unfunctionalized polyfluorinated polymer comprises polytetrafluoroethylene.

Example 56. The method of example 54, wherein the unfunctionalized polyfluorinated polymer comprises 4F-PBI.

Example 57. The method of example 54, further comprising binding an ionomer to the acid-functionalized polyfluorinated linker.

Example 58. The method of any one of examples 54-57, further comprising binding a catalyst to the acid-functionalized polyfluorinated linker.

Example 59. A polyfluorinated linker-modified polymer comprising: a polyfluorinated polymer; and a polyfluorinated linker bound to the polyfluorinated polymer by a fluorine-fluorine affinity interaction.

Example 60. The polyfluorinated linker-modified polymer of example 59, wherein the polyfluorinated polymer comprises a proton exchange membrane.

Example 61. The polyfluorinated linker-modified polymer of example 59, wherein the polyfluorinated polymer comprises an ionomer.

1. A membrane electrode assembly comprising:
a first catalyst layer:
a second catalyst layer; and
a proton exchange membrane positioned between the first catalyst layer and the second catalyst layer;
wherein at least one of the first catalyst layer, the second catalyst layer, or the proton exchange membrane comprises:
a polyfluorinated polymer; and
a polyfluorinated linker bound to the polyfluorinated polymer by a fluorine-fluorine affinity interaction.

2. The membrane electrode assembly of claim 1, wherein the polyfluorinated polymer comprises a side chain comprising an alkyl chain of one to thirty atoms and optionally has one or more pendant moieties, which may be the same or different for each atom in the side chain and which may comprise hydrogen, a hydroxyl group, a fluoro group, a chloro group, a dialkylamino group, a cyano group, a carboxylic acid group, a carboxylic amide group, an ester group, an alkyl group, an alkoxy group, or an aryl group.

3. The membrane electrode assembly of claim 1, further comprising a polyfluorinated ionomer bound to the polyfluorinated linker.

4. The membrane electrode assembly of claim 3, wherein the polyfluorinated ionomer is bound to the polyfluorinated linker by an additional fluorine-fluorine affinity interaction.

5. The membrane electrode assembly of claim 1, wherein the polyfluorinated linker further comprises a linking group comprising a tertiary amino group, an alkoxy group, an aryloxy group, a hydroxyl group, an acid group, or a derivative of any of the foregoing.

6. The membrane electrode assembly of claim 5, further comprising a catalyst bound to the polyfluorinated linker at the linking group.

7. The membrane electrode assembly of claim 6, further comprising a polyfluorinated ionomer bound to the polyfluorinated linker.

8. The membrane electrode assembly of claim 7, wherein the polyfluorinated ionomer is bound to the polyfluorinated linker by an additional fluorine-fluorine affinity interaction.

9. The membrane electrode assembly of claim 1, wherein the polyfluorinated linker comprises a polyfluorinated chain comprising one to thirty atoms.

10. The membrane electrode assembly of claim 9, wherein the polyfluorinated linker further comprises a pendant acid group.

11. The membrane electrode assembly of claim 1, wherein the polyfluorinated polymer comprises an unfunctionalized polyfluorinated polymer.

12. A method of making a membrane electrode assembly, comprising:
positioning a proton exchange membrane between a first catalyst layer and a second catalyst layer; and
forming at least one of the proton exchange membrane, the first catalyst layer, or the second catalyst layer by binding a polyfluorinated linker with a polyfluorinated polymer by a fluorine-fluorine affinity interaction.

13. (canceled)

14. The method of claim 12, wherein the forming comprises binding a polyfluorinated ionomer to the polyfluorinated linker by an additional fluorine-fluorine affinity interaction.

15. (canceled)

16. The method of claim 14, wherein the polyfluorinated linker further comprises a linking group comprising a tertiary amino group, an alkoxy group, an aryloxy group, a hydroxyl group, an acid group, or a derivative of any of the foregoing.

17. The method of claim 16, wherein the forming further comprises binding a catalyst to the polyfluorinated linker at the linking group.

18. The method of claim 17, wherein the binding the polyfluorinated linker with the polyfluorinated polymer, the binding the polyfluorinated ionomer to the polyfluorinated linker, and the binding the catalyst to the polyfluorinated linker are performed in a one-pot process.

19. The method of claim 17, further comprising:
forming a colloidal suspension comprising the polyfluorinated ionomer bound to the polyfluorinated linker and the catalyst bound to the polyfluorinated linker; and
spraying the colloidal suspension onto the polyfluorinated polymer.

20-33. (canceled)

34. A proton exchange membrane comprising:
a porous structural framework formed of a polyfluorinated polymer; and
a polyfluorinated linker bound to the polyfluorinated polymer at pore surfaces of the porous structural framework by a fluorine-fluorine affinity interaction.

35. The proton exchange membrane of claim 34, wherein the polyfluorinated polymer comprises a polytetrafluorethylene (PTFE) polymer, a polyfluorinated polybenzimidazole (PBI) polymer, or a polytrifluorostyrene polymer.

36. The proton exchange membrane of claim 34, wherein the polyfluorinated polymer comprises an ionomer.
